(19) United States
(12) Patent Application Publication
(10) Pub. No.: US 2015/0142490 A1
(43) Pub. Date: May 21, 2015

(54) SCHEDULE MANAGER

(71) Applicant: Apple Inc., Cupertino, CA (US)

(72) Inventor: Benjamin D. Georgiades, San Jose, CA (US)

(73) Assignee: Apple Inc., Cupertino, CA (US)

(21) Appl. No.: 14/081,669

(22) Filed: Nov. 15, 2013

(51) Int. Cl. G06Q 10/06

(52) U.S. Cl. CPC G06Q 10/063114
USPC 705/7.15

(57) ABSTRACT

Systems, methods, and computer-readable storage media for managing user schedules. The system presents, via a graphical user interface, an available agent scale having multiple portions including an active agent indicator portion, a first status indicator portion, a second status indicator portion, and an inactive agent portion. The active agent indicator portion can indicate a total number of agents scheduled to be active in an environment over a course of a period.

### TECHNICAL FIELD

The present technology pertains to presenting time management, and more specifically pertains to managing employee schedules in an organization.

### BACKGROUND

Scheduling is an important aspect of every project and task in an organization. Typically, employees in an organization must maintain an accurate schedule of tasks and assignments in order to adequately manage their responsibilities. Many times, managers—and even the employees themselves—have to coordinate multiple schedules when collaborating in a project or task with other employees, or otherwise as part of running the organization's affairs.

In a retail environment, managers generally have to manage and coordinate the schedules of all store employees to ensure that all scheduling requirements are met and the number of scheduled employees is suitable at all times. To this end, store managers must constantly review and modify employee schedules to optimize the overall performance of their workforce and adapt to the varying scheduling demands imposed by employees, customers, and business, while also complying with numerous legal requirements.

Not surprisingly, the complexities and challenges of managing schedules in an organization, such as a retail store, multiply as the number of employees in the organization increases. In particular, as the volume of schedules and scheduling requirements grows, it becomes increasingly difficult to quickly analyze and understand the aggregate scheduling information for the organization, as needed to optimize employee schedules and adapt to the changing circumstances of business. As a result, the process of managing schedules in an organization can be extremely time-consuming and imprecise, leading to much inefficiency in the organization. Unfortunately, current automatic scheduling systems are otherwise inflexible, and provide limited control and few options to the user. Yet in today's dynamic environment, the scheduling demands of an organization require a degree of versatility, agility, and efficiency that is not available through the current systems and solutions.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to aggregate scheduling information in an organization and generate a visually informative representation of the scheduling information, which allows users to quickly analyze and understand the various schedules of employees in the organization. The scheduling information can be dynamic, and used to generate a visual representation of a master schedule for the entire organization, with accurate indications of the current status of all active employees in the organization. The visual representation can be presented to users via a graphical user interface. Moreover, the visual representation in the graphical user interface can depict where each of the employees in the organization are currently located, and what each of the employees is currently doing. A manager can quickly glance at the visual representation and get an accurate sense of the current status of each employee in the workforce of the organization, and make any necessary adjustments to adapt to the changing circumstances of the organization. The visual representation can illustrate scheduling details, such as total active employees and current employee activities, in ways that attract the user's attention to important details and minimize unnecessary distractions from ancillary, irrelevant, or insignificant details.

The approaches herein can also be used to predict future scheduling and activity information for the organization. The predicted scheduling and activity information can be used to generate a visually informative representation of the status of the employees in the organization at a future time. The visual representation of the predicted scheduling and activity information for the organization can be presented via a graphical user interface, to help managers plan and prepare for future circumstances. For example, in a retail environment, the graphical user interface can present a visual representation indicating which employees will be on duty at a future time, which employees will be available at the future time, and/or which employees will be unavailable at the future time. The visual representation can also illustrate where each of the active employees will be assigned/located within the store, to provide an accurate portrayal of the coverage in each area of the store. The graphical user interface can present visual representations of both the current and future distributions of employees in an organization, within a single view, to help a viewer quickly review the current and future organization schedule, and compare current and future employee assignments/activity to get a sense of any emerging patterns or trajectories, for example.

Disclosed are systems, methods, and non-transitory computer-readable storage media for a schedule manager. The system presents, via a graphical user interface, an available agent scale having multiple portions comprising an active agent indicator portion, a first status indicator portion, a second status indicator portion, and an inactive agent portion, wherein the active agent indicator portion indicates a total number of agents scheduled to be active in an environment over a course of a period. In some embodiments, the available agent scale can include a dial, such as a virtual dial. The dial can have one or more of the multiple portions arranged about a perimeter of the dial. In other embodiments, the available agent scale can include a dial having a dynamic total agent scale arranged about a perimeter of the dial, the dynamic total agent scale indicating a total number of agents scheduled to be active in an environment over a course of a period.

The environment can be, for example, an organization such as a retail store or a business office. Moreover, the period can be defined based one or more factors, such as a preference, a desired scope, a parameter, or a user request. For example, the period can be a business day, a business week, a calendar month, etc. In some embodiments, the period is a business day. Thus, the available agent scale can indicate the total number of agents scheduled to be active in the environment over the course of a business day.

An agent can be an employee, a virtual agent, a resource, a representative, etc. Moreover, the total number of agents scheduled to be active can include any agents that are scheduled to work, available agents, agents on duty, agents being assigned, and/or agents employed in the environment. For example, the total number of agents scheduled to be active can include the total number of employees assigned to work over the course of the period.

The available agent scale can include a dynamic first status scale indicating a total number of active agents having a first status. Moreover, the system can retrieve data from an electronic log of employee timecard transactions to determine a number of employees having a first status. Also, the system can retrieve data from an electronic schedule to determine the total number of agents scheduled to be active in the environment over the course of the period. Further, in some cases, the system can dynamically update the dynamic active agent scale and the dynamic total agent scale at an expiration of a time interval.

Moreover, the system can present the dial and/or available agent scale via a primary view or display, while also presenting additional agent statistics and/or availability or status information via a secondary view or display. For example, the system can present a secondary display including information pertaining to a sub-environment including a respective total number of agents scale and a respective active agent scale, both the respective total number of agents scale and the respective active agent scale being respective to the sub-environment.

In some embodiments, the system can further present, via the graphical user interface, a dynamic active agent scale overlaid a portion of the dynamic total agent scale in the dial, the dynamic active agent scale indicating a total number of agents in the environment that are checked-in. Here, the dynamic active agent scale can provide a visual indication of how many of the scheduled agents are checked-in. An agent can be checked-in when he or she is present in the environment or otherwise working or available as scheduled. In some embodiments, an agent can be checked-in but on a break, lunch, or inactive period.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system for a schedule manager;

FIG. 2 illustrates an exemplary schedule manager;

FIG. 3 illustrates an exemplary graphical user interface tool for managing schedules;

FIG. 4 illustrates an exemplary view in the graphical user interface tool;

FIG. 5 illustrates a first exemplary method embodiment;

FIG. 6 illustrates a second exemplary method embodiment; and

FIGS. 7A and FIG. 7B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

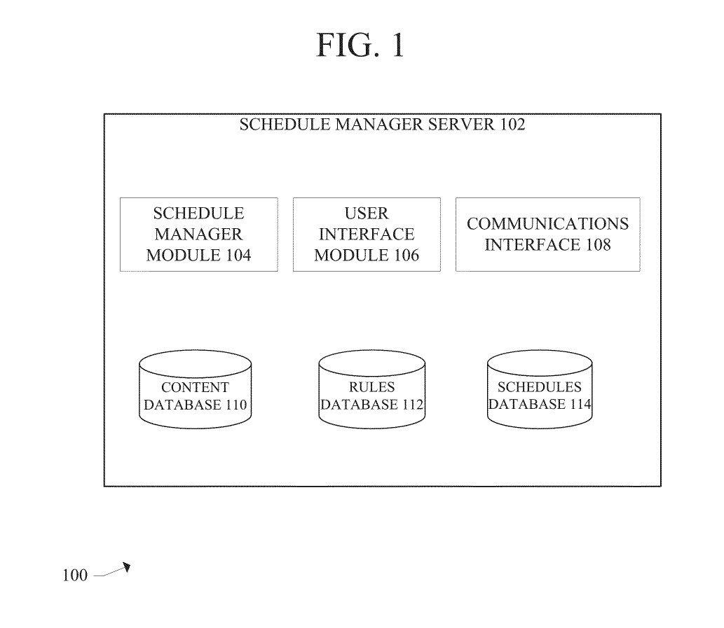

The disclosed technology addresses the need in the art for accurate and efficient schedule management tools. Disclosed are systems, methods, and non-transitory computer-readable storage media for managing user schedules using a graphical user interface tool. A brief introductory description of an exemplary graphical user interface tool for managing schedules is disclosed herein. A detailed description of graphical user interface tools for tracking and visualizing scheduling information, and exemplary variations, will then follow. These variations shall be described herein as the various embodiments are set forth. The disclosure now turns to FIG. 1.

FIG. 1 illustrates an exemplary system 100 for a schedule manager. The system can include a schedule manager server 102. The schedule manager server 102 can collect scheduling information, store agent schedules, store scheduling rules and conditions, store content for generating a scheduling manager display, and process the relevant information and generate/update a schedule manager. The schedule manager server 102 can be any computing device, such as a server, a computer, a laptop, etc.

Moreover, the schedules database 114 can store scheduling information for the organization. For example, the schedules database 114 can store every agent's individual schedule in the organization, any group schedules, any resource schedules, and/or any master schedules for the organization. The rules database 112 can store any rules, preferences, configurations, parameters, and/or conditions used by the schedule manager module 104 to process scheduling information and generate schedules and/or scales, graphs, or displays for the scheduling information. In particular, the schedule manager module 104 can analyze the information in the rules database 112 and the scheduling information in the schedules database 114 and generate a master schedule for the organization. The schedule manager module 104 can also use the information to determine current scheduling details for the entire organization, scheduling details for each area in the organization, scales or distributions of agents in each area of the organization, and/or group related scheduling details in meaningful ways, to provide scheduling breakdowns or partitions within the organization. For example, the schedule manager module 104 can use the information to determine how many agents are scheduled over a particular period, such as a day, and track how many agents from the scheduled agents (or from the entire workforce) have checked-in. The schedule manager module 104 can dynamically adjust the number of checked-in agents as agents check-out and new agents check-in. This way, the schedule manager module 104 can maintain a master schedule for the organization, and update the schedule periodically as it identifies agent and scheduling changes.

The schedule manager module 104 can also process the information to predict future scheduling details for the organizations and/or one or more areas in the organization. For example, the schedule manager module 104 can use the information to determine how many agents are scheduled for a particular period in the future, such as 30 minutes later, and how many agents are predicted to be checked-in at that future time.

The schedule manager server 102 can also include a content database 110 to store content items, such as media items, to generate visual displays and information based on the scheduling information generated by the schedule manager module 104. For example, the content database 110 can store graphics, images, videos, reports, documents, files, graphs, bars, design configurations, web content, interface elements, etc., for generating user interface displays. The user interface module 106 can be configured to use the content in the content database 110 to generate user interface displays for the scheduling information generated and/or processed by the schedule manager module 104. For example, the user interface module 106 can include instructions for generating charts, bar graphs, virtual dials, virtual knobs, maps, windows, and/or illustrations to represent scheduling details and configurations generated by the schedule manager module 104. Thus, the user interface module 106 can receive the information processed and generated by the schedule manager module 104 to generate one or more schedule manager user interfaces.

The schedule manager server 102 can also include a communications interface 108 to communicate with other devices, such as other servers or user devices. The communications interface 108 can receive scheduling information from individual agents, managers, and/or devices. For example, the communications interface 108 can receive signals from agents and/or managers as agents check-in or check-out in the organization. Moreover, the communications interface 108 can receive signals indicating that an agent has changed status and/or location. For example, the communications interface 108 can receive a signal when an agent goes on break, to indicate that the agent has changed from his or her previous location to a break location or status.

The communications interface 180 can generally govern and manage the user input and system output. There is no restriction on operating on any particular hardware arrangement and therefore the basic features here may easily be substituted for improved hardware or firmware arrangements as they are developed.

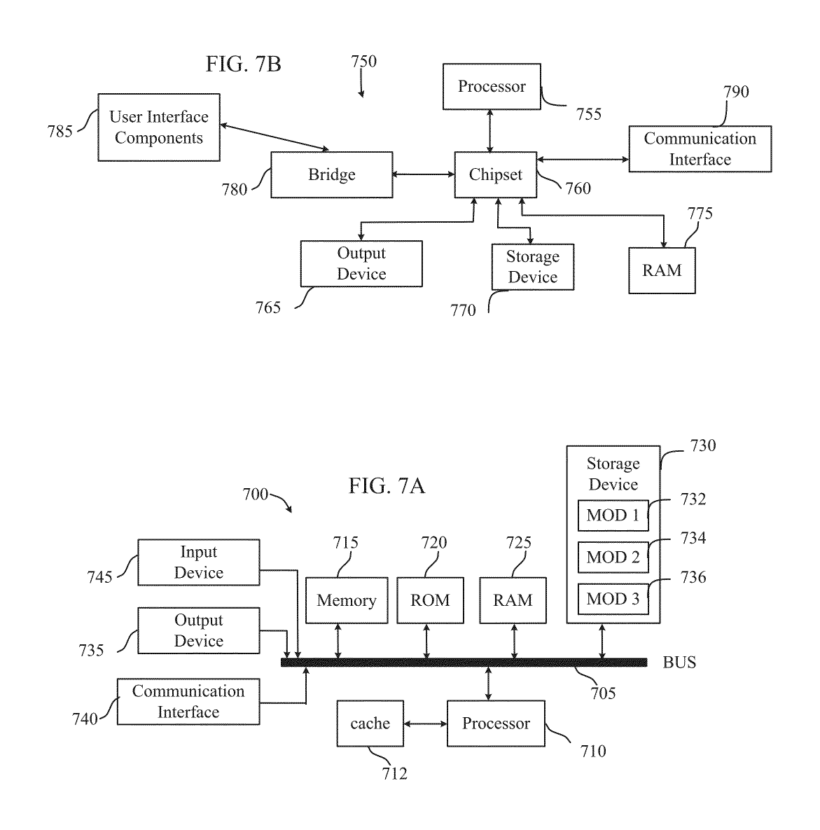

The modules and components of system 100 illustrated in FIG. 1 are for illustration purposes. As one of ordinary skill in the art will readily recognize, the system 100 and/or the schedule manager server 102 can include additional modules, devices, and/or hardware components, such as displays, processors, storage devices, input devices, memory components, system software, and so forth. For example, the schedule manager server 102 can include one or more hardware or software components described below with respect to the system in FIGS. 7A and 7B.

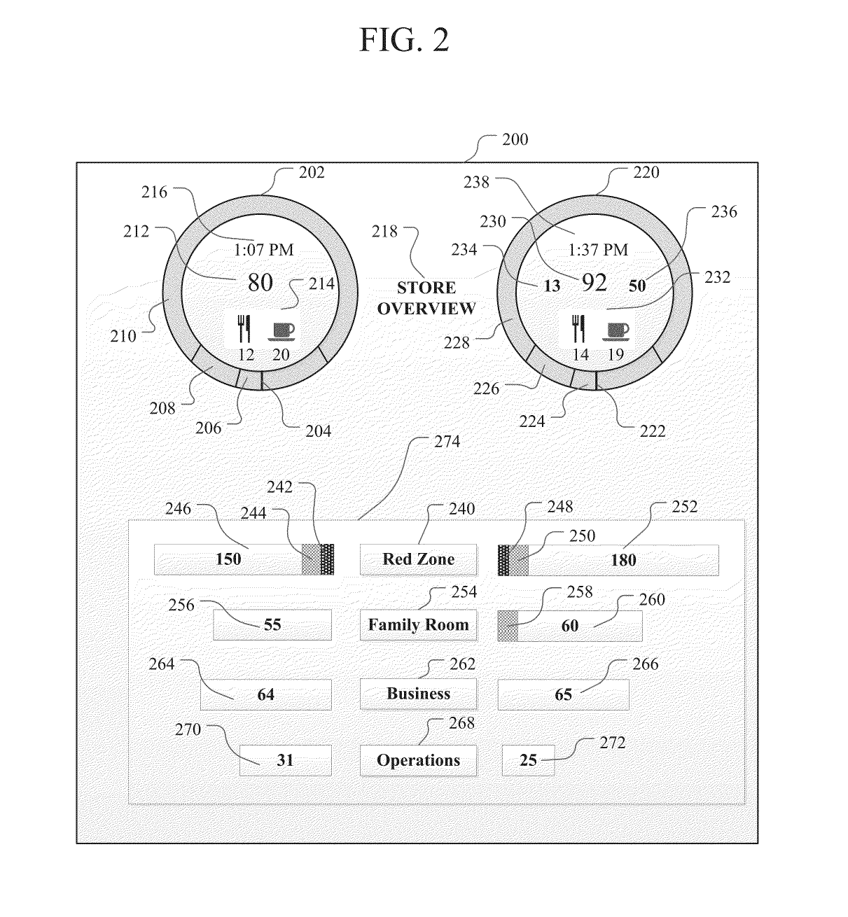

The disclosure now turns to FIG. 2, which illustrates an exemplary schedule manager 200 for a store. The schedule manager 200 can display a first dial 202 representing the total number of active agents 212 in the store from the total number of store agents scheduled for a particular period, such as a business day. The first dial 202 can be scaled at line 204 according to the total number of agents scheduled for the particular period. The first dial 202 can also include a scale 210 representing the total number of active agents at the particular period, from the total number of scheduled agents. Moreover, the first dial 202 can include additional scales 206-208 representing respective numbers of agents at other locations in the store and/or with a varying status. For example, scale 206 can represent the number of active agents on break, and scale 206 can represent the number of active agents in the family room or cafeteria. The dial 202 can also display a time 216, which corresponds to the scheduling information.

Also, icons 214 can illustrate and specify how many active agents are on lunch and on break, such as a coffee break. Though, in some embodiments, icons 214 can represent other status information, such as number of agents that are inactive but available or number of agents that are active but physically located away from the premises, for example.

The schedule manager 200 can also display a second dial 220 representing the total number of agents 230 that are predicted to be active at a future time 238, from the total number of store agents scheduled for that particular future time 238. The second dial 220 can be scaled at line 222 according to the total number of agents scheduled for the particular future time 238. The second dial 220 can also include a scale 228 representing the total, predicted number of active agents at the future time 238, from the total number of scheduled agents for the future time 238. Moreover, the second dial 220 can include additional scales 224-226 representing respective numbers of agents that are predicted to be at other locations in the store and/or have a varying status at the future time 238. For example, scale 226 can represent the predicted number of active agents on break, and scale 224 can represent the predicted number of active agents in the family room or cafeteria at the future time 238.

The second dial 220 can also include icons 232 representing a number of agents that are predicted to be in particular areas at the future time 238, such as lunch or coffee break. Moreover, the second dial 220 can also include a check-in number 234, corresponding to the predicted number of agents to check-in at the future time 238, and a check-out number 236, corresponding to the predicted number of agents to check-out at the future time 238.

The schedule manager 200 can also include a secondary display 274 providing specific details for each of the areas 240, 254, 262, and 268 of the organization. Each of the areas 240, 254, 262, and 268 can include graphs representing the current and predicted status of scheduled agents in associated areas. For example, the red zone area 240 of the store (i.e., the store floor) can include a bar with a block 246 representing the active agents currently scheduled at the red zone area 240, a block 244 representing the active agents in the red zone area 240 that are on break, and a block 242 representing the active agents in the red zone area 240 that are at lunch. Similarly, the red zone area 240 can include a bar with predicted status information for the agents at the future time 238. For example, blocks 248-252 can represent the predicted number of respective agents that will be in the red zone area 240, on break, and at lunch.

Likewise, the family room area 254 can include a current bar 256 and a future bar 260 representing the number of active agents in the family room area 254 and the predicted number of active agents that will be in the family room area 254 at the future time 238. Block 258 of bar 260 can also represent the number of agents that are predicted to be on break at the future time 238.

The business area 262 can include a current bar 264 and a future bar 266 representing the number of active agents in the business area 262 and the predicted number of active agents that will be in the business area 262 at the future time 238. Similarly, the operations area 268 can include a current bar 270 and a future bar 272 representing the number of active agents in the operations area 268 and the predicted number of active agents that will be in the operations area 268 at the future time 238.

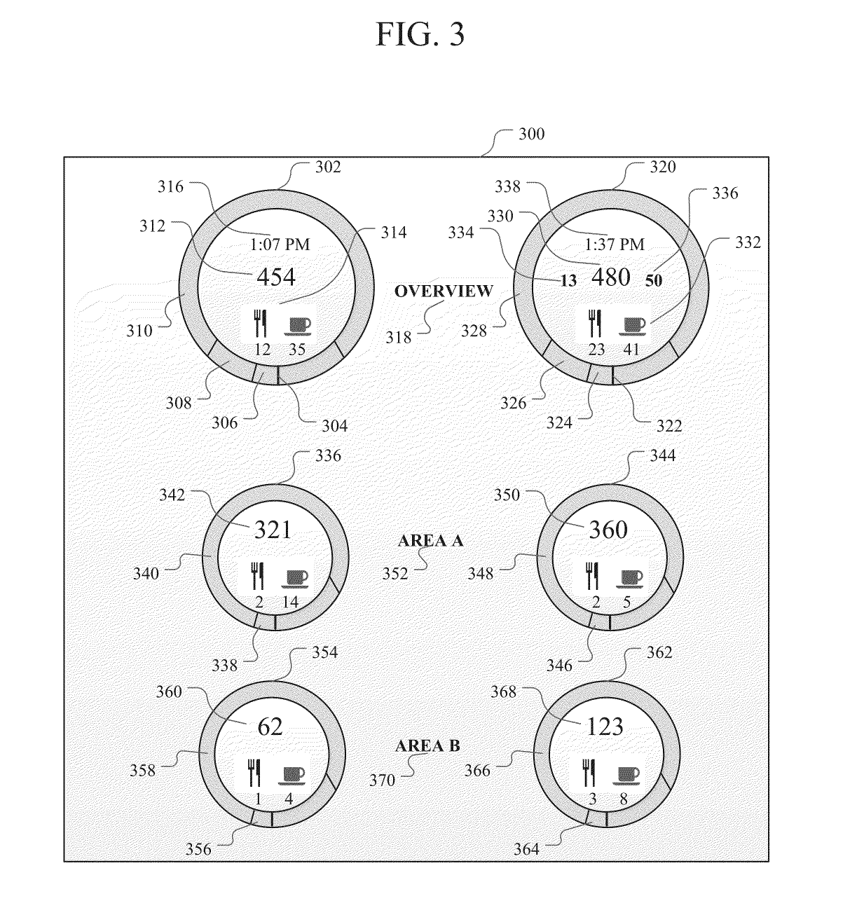

FIG. 3 illustrates an exemplary graphical user interface tool 300 for managing schedules. The graphical user interface tool 300 can be used to manage schedules in an organization, such as a retail store, for example. The graphical user interface tool 300 can visually depict workforce conditions or status in the organization via dials 302 and 320. Dials 302 and 320 can represent an overview 318 of the organization. Here, dial 302 depicts the current distribution of agents in the organization, and dial 320 depicts the predicted distribution of agents in the organization 30 minutes later.

Line 304 in dial 302 represents the maximum number of agents in the organization. For example, line 304 can represent the total number of agents currently employed by the organization, or otherwise associated with the organization. A user can thus view dial 302 and quickly know the total number of agents in the organization by simply looking at line 304. Label 312 specifies the current number of active agents in the organization. Thus, label 312 visually indicates how many agents are active from the total number of agents indicated by line 304. In FIG. 1, label 312 indicates that currently there are 454 active agents in the organization. The dial 302 can also include the current time 316 to identify the time of the information represented in the dial 302.

Blocks 306-310 represent respective number of agents located in corresponding areas of the organization. For example, block 306 can indicate the number of agents currently on break, block 308 can indicate the number of agents currently in the family room, and block 310 can indicate the number of agents in the main office area of the organization. Accordingly, blocks 306-310 can visually depict the ratio of agents at each corresponding area of the organization. Based on blocks 306-310, a user can view dial 302 and quickly ascertain the current distribution of agents in the organization. In some embodiments, blocks 306-310 can be colored or otherwise include markings or patterns based on the areas of the organization they represent. For example, the blocks 306-310 can be colored based on a color-coding scheme. Thus, if the color-coding scheme specifies that the main office area of the organization should be represented by a red block in the dial 302, and block 310 represents the agents currently in the main office area, then block 310 can be filled in red.

Color coding the blocks 306-310 can help the user easily identify what area within the organization each of the blocks 306-310 is associated with. For example, if the user knows that red is associated with the main office area and yellow is associated with the family room, the user can view the dial 302 and quickly identify how many agents are in the main office area and the family room by looking at the red and yellow blocks in the dial 302. The blocks 306-310 can also be labeled according to the area they represent. For example, block 310 can be labeled “Main Office” to indicate that it represents the current number of agents in the main office area. Labeling the blocks 306-310 can be particularly helpful in situations where the number of areas depicted in the dial 302 and/or the number of colors in the color-coding scheme are numerous and likely to confuse the user. On the other hand, in some cases, labeling the blocks 306-310 can cause visual clutter and/or may be less suitable or desirable than simply coloring the blocks 306-310 according to a color scheme.

As one of ordinary skill in the art will readily recognize, the blocks 306-310 can include any coloring, labeling, and/or markings to associate the blocks 306-310 with corresponding areas of the organization. The format and presentation of the blocks 306-310 can thus be modified according to specific preferences and/or circumstances.

In addition, the dial 302 can include icons 314 representing the number of agents that are currently in the dining room and/or coffee room. A user can thus look at icons 314 and determine how many users are currently on break. In some cases, this can help a manager determine how many users are not currently at a business area of the organization, how many users are not currently assigned to an area, and/or how many users are not active but otherwise available. For example, if a specific area needs more agents, a manager can determine how many users are on break but will otherwise be available to attend to the area in need. In some embodiments, icons 314 can represent any other area or agent status. For example, icons 314 can represent a number of agents in a recreational room, a meeting, a presentation, a training, commuting, on the phone, etc.

With respect to dial 320, this dial can minor dial 302 but otherwise represent a future distribution of agents predicted for a particular time 338. For example, dial 320 can indicate how many users are predicted to be active in the organization at the particular time, and what the predicted distribution of agents is for that particular time. Here, label 330 can specify how many users are predicted to be active in the organization at the particular time 338. Thus, for example, label 330 in FIG. 3 indicates that 480 agents are predicted to be active in the organization at the particular time 338, which is 30 minutes after the current time. Moreover, line 322 can represent the predicted maximum number of agents at the particular time 338. For example, line 322 can represent the total number of agents that are predicted to be employed at the organization at that particular time 338. In many cases, the maximum number of agents in dial 302, represented by line 322, will be the same as in dial 320. However, the maximum number of agents in dial 320 can differ in some cases from that of dial 302. For example, line 304 in dial 302 can differ from line 322 in dial 320 if there are any expected changes in the workforce between the current time and the particular time 338 in the future.

Like blocks 306-310, blocks 324-328 in dial 320 represent respective numbers of active agents at the corresponding areas within the organization. However, unlike blocks 306-310, which represent the distribution of active agents at the current time, blocks 324-328 represent the distribution of active agents at the particular time 338 in the future. Thus, blocks 324-328 represent the projected state of blocks 306-310 at the particular time 338.

Also, icon 332 can represent the number of agents that are predicted to be in the dining room and/or coffee room at the particular time 338. For example, icon 332 indicates that 23 agents are predicted to be dining and 41 agents are predicted to be on coffee break at the particular time 338, whereas 12 agents are currently dining and 35 are currently on coffee break, as indicated by icon 314 in dial 302. As previously mentioned, in other embodiments, icon 332 can be configured to represent other areas and/or activities than those depicted in FIG. 3.

In addition, dial 320 can also include a clock-out number 334, which indicates how many agents are predicted to clock-out at (or by) the particular time 338, and a check-in number 336, which indicates how many agents are predicted to clock-in at (or by) the particular time 338.

Either dial 302 and/or dial 320 can also include additional graphical elements or indications representing other statistics, predictions, and/or scheduling information. For example, in some embodiments, dials 302 and 320 can include a block and/or label indicating a number of agents that are off, but otherwise on-duty and available to check-in.

The user interface tool 300 can also include current dials 336 and 354 and future dials 344 and 362 for one or more areas within the organization. The dials 336 and 354 can indicate the number of active agents at respective areas 352 and 370 of the organization, as well as a distribution of agents within any subareas at the respective areas 352 and 370. Similarly, dials 344 and 362 can indicate the predicted number of active agents within respective areas 352 and 370 of the organization at the particular time 338, as well as a predicted distribution of agents within any subareas at of the respective areas 352 and 370. In some embodiments, the dials 336, 344, 354, and 362 can be generated automatically when the dials 302 and 320 are generated. In other embodiments, the dials 336, 344, 354, and 362 can be generated in response to a user input. For example, dials 336, 344, 354, and 362 can be generated in response to a selection by the user of one or more corresponding blocks or labels from dials 302 and/or 320. Thus, if a user selects a block in dial 302 that represents the agents in area 352, in response, the graphical user interface tool 300 can generate dials 336 and 344 corresponding to area 352. In this sense, the various components in the dials can be user-selectable or links to additional details about corresponding areas.

More specifically, dial 336 can represent the status and distribution of agents in area 352. Here, dial 336 can include blocks 338 and 340, corresponding to the number of agents in associated subareas of area 352. Blocks 338 and 340 can be user-selectable, or otherwise include links to additional information. In some embodiments, when a user selects one of the blocks 338 and 340, the graphical user interface tool 300 can generate an additional dial corresponding to subareas associated with the area of the selected block. Dial 336 can also include a visual indication 342 of the number of agents currently in area 352. Thus, in FIG. 3, the visual indication 342 in dial 336 indicates that there are 321 agents in area 352. On the other hand, dial 344 can represent the predicted status and distribution of agents in area 352 at the particular time 338. Here, dial 344 can include blocks 346 and 348, corresponding to the predicted number of agents in associated subareas of area 352. Moreover, blocks 346 and 348 can also be user-selectable, or otherwise include links to additional information. Further, similar to dial 336, dial 344 can also include a visual indication 350 of the predicted number of agents in area 352 at the particular time 338. As illustrated in FIG. 3, the visual indication 350 in dial 344 indicates that there are 360 agents predicted to be in area 352 at the particular time 338. Accordingly, by looking at the visual indications 342 and 350, a user can quickly determine that 321 agents are currently in area 352, and 360 agents (39 additional agents) are predicted to be in area 352 in 30 minutes (i.e., at time 338).

Dial 354 can represent the status and distribution of agents in area 370. Here, dial 354 can include blocks 356 and 358, corresponding to the number of agents in associated subareas of area 370. Dial 354 can also include a visual indication 360 of the number of agents currently in area 370. On the other hand, dial 362 can represent the predicted status and distribution of agents in area 370 at the particular time 338. Here, dial 362 can include blocks 364 and 366, corresponding to the predicted number of agents in associated subareas of area 370. Dial 362 can also include a visual indication 368 of the predicted number of agents in area 370 at the particular time 338.

As one of ordinary skill in the art will readily recognize, the areas depicted in a dial can include any number of subareas configured for representation. For example, the areas depicted in a dial representing an organization can include some of the areas of the organization, all of the areas in the organization, or only those areas having agents.

In some embodiments, the graphical user interface tool 300 can also include a bar graph representing the current distribution of agents and/or the future distribution of agents. For example, the bar graph can include bars representing agents in each of the areas in the organization, or at least those areas having one or more agents. The bars can be sized proportionally based on the number of respective agents in the associated areas. Moreover, the bars can include links to further details about the associated bars. For example, a bar representing a sales floor in a retail store can be user-selectable, such that the user can select the bar to obtain additional details about the sales floor. In response, the graphical user interface tool 300 can generate and/or display another bar graph representing subareas within the sales floor, another dial representing subareas within the sales floor, a table with information about agents in the sales floor, additional statistics, a pop-up with information about the sales floor, etc. In some cases, the user can also scroll over a bar to prompt the graphical user interface tool 300 to display a pop-up with additional details about the specific bar.

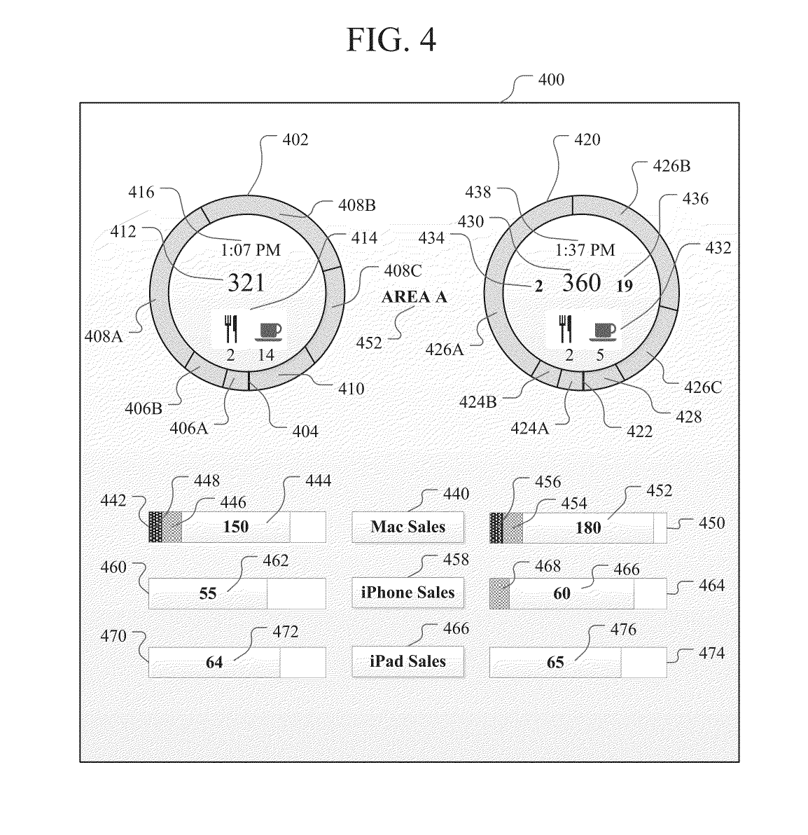

FIG. 4 illustrates an exemplary view 400 in the graphical user interface tool. The view 400 can be a detailed view of an area presented in the graphical user interface tool 300 illustrated in FIG. 3. In this example, the view 400 is a detailed view of area 352 from FIG. 3. Here, the view 400 can be generated when a user selects area 352 within the graphical user interface tool 300 in FIG. 3, or otherwise interacts with area 352 in FIG. 3. Thus, the graphical user interface tool 300 can detect that the user desires to view additional information about area 352 and, in response, generate and/or present view 400 with additional details about area 352.

The view 400 can includes a first and second graphical dial 402 and 420. The first graphical dial 402 can represent a current distribution of agents in area 352, and the second graphical dial 420 can represent a future distribution of agents in area 352. In some cases, the first and second graphical dial 402 and 420 can be the same as the first and second graphical dial 335 and 344 in FIG. 3, respectively, which also represent area 352. However, in some cases, the first and second graphical dial 402 and 420 can depict additional details than the first and second graphical dial 335 and 344 in FIG. 3. In particular, the first and second graphical dial 402 and 420 can depict a more detailed distribution of subareas within area 352 than the first and second graphical dial 335 and 344 in FIG. 3.

For example, as previously mentioned in FIG. 3, dial 336 can represent the status and distribution of agents in area 352, and dial 344 can represent the predicted status and distribution of agents in area 352 at the particular time 338. Dial 336 can include blocks 338 and 340, corresponding to the distribution of active agents in area 352. Similarly, dial 344 can include blocks 346 and 348, corresponding to the predicted distribution of active agents in area 352 at a future time. As an example, assume that blocks 338 and 340 in dial 336 correspond to the number of agents on break and the number of agents on the sales floor, respectively. Likewise, assume that blocks 346 and 348 in dial 344 respectively correspond to the predicted number of agents that will be on break and the predicted number of agents that will be on the sales floor at a future time. On the other hand, dial 402 in FIG. 4 can include additional blocks to depict additional details, or sub blocks, within blocks 338 and 340 in FIG. 3. For example, block 338 in FIG. 3, which, in this example, can represent agents on break, can be further divided into blocks 406A-B to indicate the number of agents on break in the family room 406A and the cafeteria 406B. This way, dial 402 can provide a more granular view of the distribution of agents on break.

Likewise, block 340 in FIG. 3, which, in this example, can represent agents on the sales floor, can be further divided into blocks 408A-C to indicate the number of agents in the Mac section 408A of the floor, the iPhone section 408B of the floor, and the iPad section 408C of the floor. Thus, dial 402 can also provide a more granular view of the distribution of agents within sections of the sales floor.

In addition, dial 402 can include an indication of the number of active agents 412, the number of agents that are not currently working 410, the current time 416, and icons 414, which can include further indications of activity and/or subareas, such as lunch breaks, for example. Similarly, dial 420 can include an indication of the predicted number of active agents 430 at a future time 438, the number of agents that are not predicted to be working 428 at the future time 438, and icons 432, which can include further indications of predicted activity and/or subareas, such as lunch breaks, for example. Moreover, dial 420 can also include an indication 434 of agents that are predicted to check-in and an indication 436 of agents that are predicted to check-out.

Dial 420 can also include the blocks illustrated in dial 402, but otherwise represent the future distributions of agents in the corresponding subareas. For example, blocks 424A-B can indicate the number of agents that are predicted to be on break in the family room 424A and the cafeteria 424B at the future time 438. Moreover, blocks 426A-C can indicate the number of agents that are predicted to be in the Mac section 426A of the floor, the iPhone section 426B of the floor, and the iPad section 426C of the floor at the future time 438.

The view 400 can also include bars 442, 450, 460, 464, 470, and 474 to further depict the distribution of agents within blocks 408A-C and 426A-C in dials 402 and 420. For example, bars 442, 450, 460, 464, 470, and 474 can provide a further distribution of agents in the Mac sales area 440, the iPhone sales area 458, and the iPad sales area 466, which correspond to blocks 408A-C and 426A-C in dials 402 and 420. More specifically, bar 442 can represent that total number of agents in the store that can be scheduled for the Mac sales area 440. Bar 442 can further include a block 444 that indicates the number of agents that are currently in the Mac sales area 440. In this example, block 444 specifies that 150 agents are currently in the Mac sales area 440 of the sales area in the store. In addition, bar 442 can include blocks 446 and 448 to indicate a specific characteristic of agents from the Mac sales area 440. For example, block 446 can represent the number of managers in the Mac sales area 440, the number of sales representatives in the Mac sales area 440, the number of agents on break from the Mac sales area 440, etc. As another example, block 446 can represent the number of agents from the Mac sales area 440 that are currently in the family room, and block 448 can represent the number of agents from the Mac sales area 440 that are currently in the coffee room. This way, a user can look at the view 400 and quickly identify how many agents are currently in the Mac sales area 440 of the sales area, and how many agents from the Mac sales area 440 are on break, for example.

Bar 450 can represent the future distributions of agents in the Mac sales area 440, as predicted by the system. Thus, bar 450 can represent the information in bar 442 adjusted based on predicted changes at the future time. For example, bar 450 can represent a predicted total number of agents in the store that can be scheduled for the Mac sales area 440 at a future time. Bar 450 can include a block 452 that indicates the number of agents that are predicted to be in the Mac sales area 440. In this example, block 452 specifies that 180 agents are predicted to be in the Mac sales area 440 at the future time. This is up from the 150 agents that are in the Mac sales area 440 at the present time. Thus, at the future time, there are 30 more agents that are predicted to be in the Mac sales area 440 than the present time.

In addition, bar 450 can include blocks 454 and 456 to indicate a specific characteristic of agents from the Mac sales area 440 at the future time, as previously explained in the discussion of bar 442. For example, block 454 can represent the number of agents from the Mac sales area 440 that are predicted to be in the family room at the future time, and block 456 can represent the number of agents from the Mac sales area 440 that are predicted to be in the coffee room at the future time.

Bar 460 can represent the total number of agents that can be scheduled for the iPhone sales area 458. Here, block 462 can represent the number of agents that are currently in the iPhone sales area 458. On the other hand, bar 464 can represent the predicted total number of agents that can be scheduled for the iPhone sales area 458 at the future time. Bar 464 can include blocks 466 and 468. Block 466 can represent the number of agents that are predicted to be in the iPhone sales area 458 at the future time. Block 468 can represent, for example, the number of agents in the iPhone sales area 458 that are predicted to be on break at the future time.

Bar 470 can represent the total number of agents that can be scheduled for the iPad sales area 466. Here, block 472 can represent the number of agents currently in the iPad sales area 466. Bar 474 can represent the predicted total number of agents that can be scheduled for the iPad sales area 466 at the future time. In this example, block 476 can represent the number of agents that are predicted to be in the iPad sales area 466 at the future time.

As one of ordinary skill in the art, the divisions depicted in bars 442, 450, 460, 464, 470, and 474 can vary in different embodiments, depending on specific settings, configurations, and parameters set for the bars 442, 450, 460, 464, 470, and 474. For example, in some embodiments, the bars 442, 450, 460, 464, 470, and 474 can be divided into blocks that indicate the respective distribution of specific types of agents, such as managers or sales representatives, within the corresponding areas. In other embodiments, the bars 442, 450, 460, 464, 470, and 474 can be divided into blocks based on specific activities of agents within the corresponding areas. Other partition schemes are also contemplated herein.

Moreover, in some embodiments, the areas 440, 458, 466 can be selected by a user to generate an updated view with additional information about the selected area. For example, the user can click on area 440 to generate additional dials and/or bars corresponding to subareas within area 440.

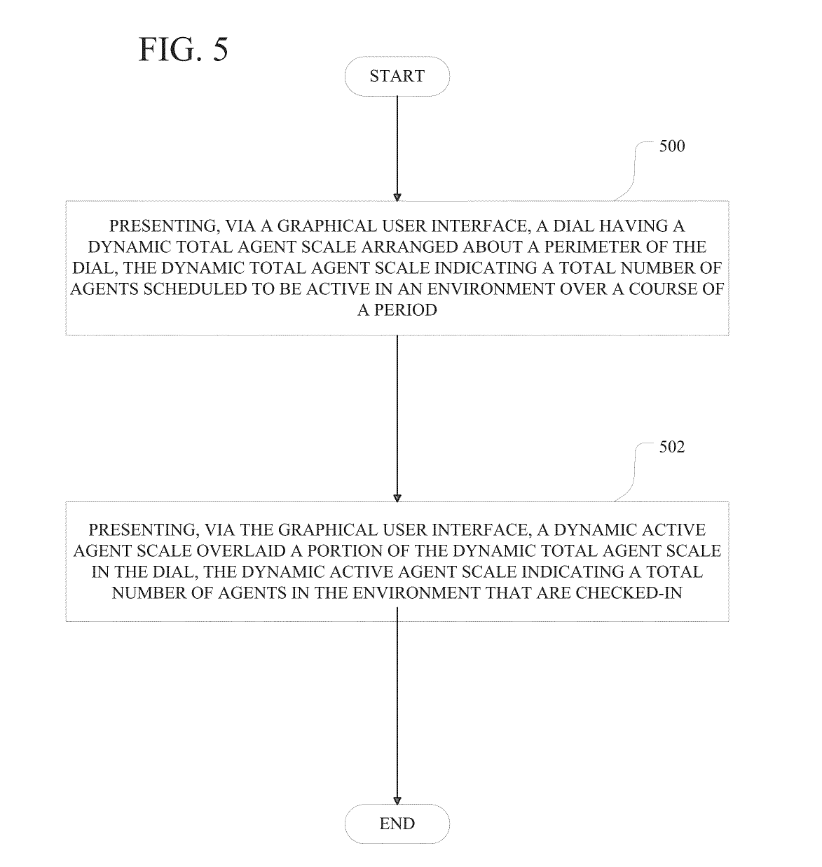

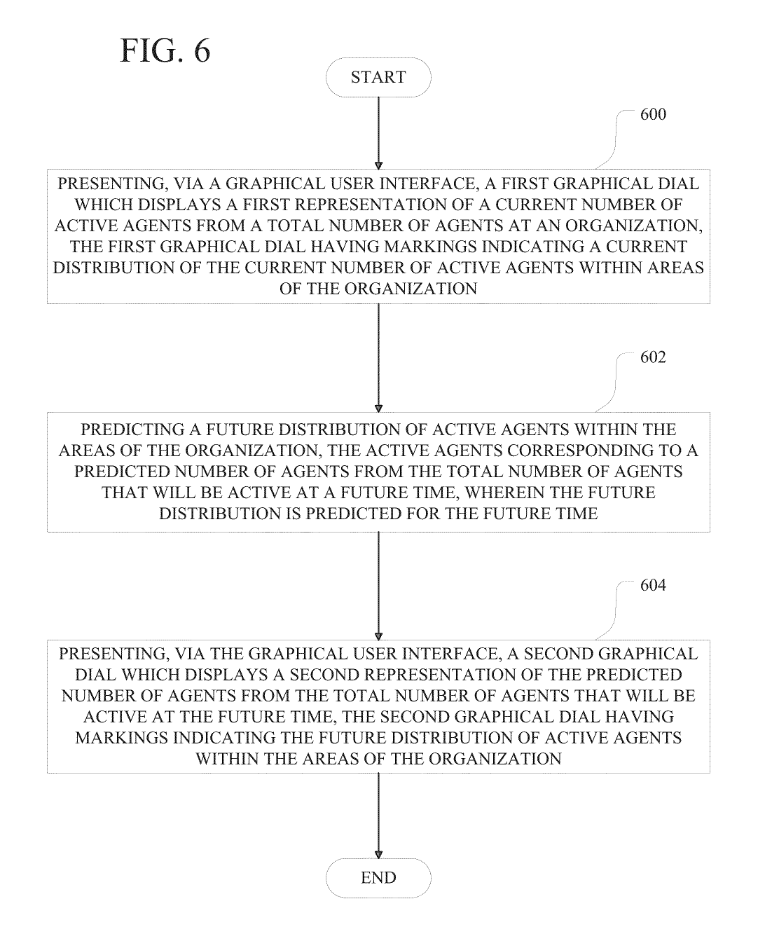

Having disclosed some basic system components and concepts, the disclosure now turns to the exemplary method embodiments shown in FIGS. 5 and 6. For the sake of clarity, the methods are described in terms of a system, such as system 100 shown above in FIG. 1, configured to practice the method. The steps outlined herein are exemplary and can be implemented in any combination thereof, including combinations that exclude, add, or modify certain steps.

FIG. 5 illustrates a first exemplary method embodiment. First, the system 100 presents, via a graphical user interface, a dial having a dynamic total agent scale arranged about a perimeter of the dial, the dynamic total agent scale indicating a total number of agents scheduled to be active in an environment over a course of a period (500). The environment can be, for example, an organization such as a retail store or a business office. Moreover, the period can be defined based one or more factors, such as a preference, a desired scope, a parameter, or a user request. For example, the period can be a business day, a business week, a calendar month, etc. In some embodiments, the period is a business day. Thus, the dynamic total agent scale can indicate the total number of agents scheduled to be active in the environment over the course of a business day.

An agent can be an employee, a virtual agent, a resource, a representative, etc. Moreover, the total number of agents scheduled to be active can include any agents that are scheduled to work, available agents, agents on duty, agents being assigned, and/or agents employed in the environment. For example, the total number of agents scheduled to be active can include the total number of employees assigned to work over the course of the period.

Next, the system 100 presents, via the graphical user interface, a dynamic active agent scale overlaid a portion of the dynamic total agent scale in the dial, the dynamic active agent scale indicating a total number of agents in the environment that are checked-in (502). Here, the dynamic active agent scale can provide a visual indication of how many of the scheduled agents are checked-in. An agent can be checked-in when he or she is present in the environment or otherwise working or available as scheduled. In some embodiments, an agent can be checked-in but on a break, lunch, or inactive period.

The dial can include a dynamic first status scale indicating a total number of checked-in agents having a first status. Moreover, the system 100 can retrieve data from an electronic log of employee timecard transactions to determine a number of employees having a first status. Also, the system 100 can retrieve data from an electronic schedule to determine the total number of agents scheduled to be active in the environment over the course of the period. Further, in some cases, the system 100 can dynamically update the dynamic active agent scale and the dynamic total agent scale at an expiration of a time interval.

In some embodiments, the system 100 can present the dial at a primary display, and present additional information at one or more other displays. For example, the system 100 can present the dial at a primary display and further present a secondary display including information pertaining to a sub-environment including a respective total number of agents scale and a respective active agent scale, both the respective total number of agents scale and the respective active agent scale being respective to the sub-environment.

In other embodiments, the system can present, via a graphical user interface, an available agent scale having multiple portions comprising an active agent indicator portion, a first status indicator portion, a second status indicator portion, and an inactive agent portion. The active agent indicator portion can indicate a total number of agents scheduled to be active in the environment over the course of a period. In some cases, the available agent scale can include a dial, such as a dial as previously described herein. Moreover, the dial can have one or more of the multiple portions arranged about a perimeter of the dial. The dial can display the multiple portions on the dial, overlaid one another. The multiple portions can be proportional and, thus, when overlaid one another, can provide a visual indication of the different ration of agents associated with each of the portions.

FIG. 6 illustrates a second exemplary method embodiment. Here, the system 100 first presents, via a graphical user interface, a first graphical dial which displays a first representation of a current number of active agents from a total number of agents at an organization, the first graphical dial having markings indicating a current distribution of the current number of active agents within areas of the organization (600). Active agents can include available agents, scheduled agents, agents that are on duty, agents that are currently at a physical or virtual location of the organization, and so forth. However, in some embodiments, active agents can even include resources, such as printers, registers, equipment, kiosks, automated systems, customer interfaces, etc. Thus, for example, the term active agents can refer to employees or resources, such as kiosks, that are present at the organization.

The organization can be, for example, a retail store, a service center, a super market, a mall, an office, a hospital, an airport, a factory, a distribution center, a municipality, etc. In some cases, the organization can be composed of multiple entities or organizations, such as a retail chain or franchise having multiple stores, for example. Moreover, the areas within the organization can refer to physical areas, such as a break room or a sales room; functional areas, such as departments; virtual areas; categories of activities, such as sales and technical support; aisles; buildings; product areas; etc. Indeed, as one of ordinary skill in the art will readily recognize, the areas within the organization can refer to any type of divisions or partitions of the organization that can be represented in a graphical user interface and can include corresponding scheduling information and/or requirements.

The current distribution of active agents can include the number and/or identity of agents currently in each of the areas within the organization, based on a status or location of each agent. For example, the current distribution can specify which active agents are currently assigned or located in each of the areas within the organization. The current distribution can depict the different areas within the organization and indicate which agents, or how many agents, are actively within each of the different areas. For example, if the organization is a retail store and the areas include a showroom, a cafeteria, and a stock room, the current distribution can indicate how many agents are currently in the showroom, how many agents are currently in the cafeteria, and how many agents are currently in the stock room. Here, the current distribution can indicate groups of agents corresponding to respective areas. In some cases, the current distribution can also indicate which specific agents are currently in the showroom, which specific agents are currently in the cafeteria, and which specific agents are currently in the stock room. This way, the current distribution can track the number of agents at each location, as well as the identity of each agent. In other words, if there are currently two agents on break, the current distribution can indicate not only that two agents are on break, but also that the two agents are Bob and Mary. In some cases, a user can click or select a user, such as Bob, and view the history, movement, and/or activity of that user within the graphical user interface. This way, a user or manager can track individual statistics of agents and determine if a specific agent is located in the wrong area or should otherwise be relocated.

Furthermore, the current distribution can be illustrated using visual markings, such as colors, shapes, lines, text, objects, etc. For example, the current number of active agents can be visually illustrated and partitioned by color, and each of the different areas of color can correspond to the number of current agents in an associated area of the organization. Thus, the first graphical dial can display the current number of active agents with color-coded divisions corresponding to the different areas in the organization, where each of the divisions is proportional based on the respective number of active agents in the corresponding area. For example, the first graphical dial can visually indicate that 100 agents are currently active from a total of 150 agents in the organization. The current distribution can further indicate that 100 agents are currently in the showroom, 45 agents are currently in the stock room, and 5 agents are currently in the cafeteria. Here, a portion of the agents corresponding to the 100 agents in the showroom can be colored in red, for example, to visually represent the number of agents currently in the showroom. Moreover, a portion of the agents corresponding to the 45 agents in the stock room can be colored in blue to visually represent the number of agents currently in the stock room. Finally, a portion of agents corresponding to the 5 agents in the cafeteria can be colored yellow to visually represent the number of agents currently in the cafeteria. Each portion can be sized based on the corresponding number of agents in that area, to visually indicate the respective ratio or proportion of current agents in each area. This way, a user can look at the first graphical dial and quickly identify the current number of active agents in the organization, and the number of agents in each area relative to one another.

To calculate the current distribution, the system 100 can dynamically track the location and/or status of each agent in the organization. The system 100 can monitor agent activity and each of the areas of the organization. The system 100 can also receive input from users with status information for one or more agents. Moreover, the system 100 can analyze the agents' schedules to determine where each agent is scheduled to be. In addition, the system 100 can infer status information based on specific activities or transactions. For example, the system 100 can analyze sales transactions to determine location and/or status information for those agents conducting the sales transactions. The system 100 can track status information for active agents or receive the information from a server that collects and/or maintains status information.

Next, the system 100 predicts a future distribution of active agents within the areas of the organization, the active agents corresponding to a predicted number of agents from the total number of agents that will be active at a future time (602). The future distribution can include a prediction of how many agents will be active within each area of the organization at the future time. Here, the system 100 can predict how many total agents will be active at the future time, and what the distribution or locations of the active agents will be within the areas of the organization at the future time. For example, the system 100 can predict that, in 30 minutes, 120 agents out of a total of 150 agents will be active, and, from the active 120 agents, 100 agents will be in the showroom, 15 agents will be in the stock room, and 5 agents will be in the cafeteria taking a break.

The system 100 can predict the future distribution based on the current distribution, individual agent schedules, a master schedule of the organization, monitored data, statistics, current or previous patterns, current activity, business objectives or demands, customer data, sales transactions, user input, workload, status information, context information, performance information, estimated progress information, estimated demands, preferences, restrictions, and so forth. For example, in a retail environment, the system can predict the future distribution based on employee schedules, current sales activity, and estimated sales activity at the future time. The system 100 can predict the future distribution using a prediction algorithm configured to predict a distribution based on one or more factors. Further, the system 100 can dynamically predict the future distribution, and update prior predictions after an event, such as a user request or an interval of time.

Moreover, the future time can be any time specified/configured in the prediction algorithm. For example, the future time can be 30 minutes after the current time. In some cases, the future time configured for the prediction algorithm can be based on specific circumstances, such as a current context or current planning requirements. The time for prediction can also be optimized based on the organization, preferences, patterns, statistics, performance, planning objectives, etc. For example, the future time can be configured to be 30 minutes after the current time but later modified to 1 hour after the current time based on one or more factors.

The system 100 then presents, via the graphical user interface, a second graphical dial which displays a second representation of the predicted number of agents from the total number of agents that will be active at the future time, the second graphical dial having markings indicating the future distribution of active agents within the areas of the organization (604). The second graphical dial can be generated based on the information previously predicted by the system 100, including the future distribution and any other future estimates. Moreover, the second graphical dial can be similar to the first graphical dial, as described above, but otherwise reflect the scheduling information of the organization and agents at the future time. This way, a user can view the second graphical dial and quickly obtain an idea of how many agents will be active at the future time, and how many agents will be at each of the areas within the organization. Thus, the second graphical dial can provide a visual map of the agents in the organization at the future time. A manager, for example, can quickly look at the current distribution of active agents through the first graphical dial and the future distribution of active agents through the second graphical dial, and easily reorganize agents, assignments, or schedules as necessary to meet demands or changing circumstances. The manager can compare the current distribution with the future distribution to identify any patterns, such as workforce, performance, or scheduling patterns, and also get a sense to what the status of the organization is with respect to workload, capacity, performance, workforce, flexibility, scheduling, and so forth.

In some embodiments, the system 100 can also present a bar graph representing the current distribution and/or the future distribution of active agents. Each bar on the graph can represent a specific area within the organization, and can be sized relative to the number of active agents in the corresponding area of the organization. Moreover, the bar graph can be color-coded, with each bar being colored based on a corresponding area of the organization it represents. In some cases, the bars can include links to other information, such as additional details about the corresponding area represented by the bar. The bars can also be user-selectable. Here, the user can select or click on a bar to view additional information associated with that particular bar.

Moreover, when the user selects a bar, the system 100 can also generate a bar graph representing the additional information associated with the selected bar. For example, the bar can represent an overview of a showroom in a store, where the showroom includes multiple subareas. When the user selects the bar associated with the showroom, the system 100 can present a bar graph representing the various subareas in the showroom. Each bar in the showroom bar graph can represent a number of active agents in a specific subarea of the showroom. In some cases, the specific subarea can also be selected by the user to generate a further representation of subareas within the specific subarea. This way, the user can use the bars to navigate through one or more layers of scheduling or status information. The number of layers of information that the user can navigate can depend on the organization, specific areas in the organization, system preferences, etc. Further, when a user selects a bar, the system can also generate a new graphical dial based on subareas associated with the area corresponding to the selected bar. The new graphical dial can be generated in addition to the new bar graph, or in lieu of the new bar graph.

In some embodiments, the system 100 can generate other types of graphical elements to provide visual representations of the scheduling information for the organization, as well as the status information of the agents and areas within the organization. The other types of graphical elements can be used in addition to, or in lieu of, the first and second graphical dials. For example, instead of using virtual dials, the system can depict status and scheduling information using one or more charts, graphs, maps, tables, blueprints, images, pies, blocks, icons, or objects. In some embodiments, the system can generate a map of the organization with color-coded objects representing a number of active agents for each area within the organization. The objects can be sized relative to the total number of active agents in the organization and the respective number of active agents in each of the other areas of the organization. For example, the system 100 can generate a map of the organization, and include a blue avatar in the showroom area of the organization for each active agent that is currently in the showroom, and a red avatar in the cafeteria for each agent that is currently in the cafeteria. Thus, the map of the organization can include, for example, a group of blue avatars in the showroom area, where the size of the group is proportional to the number of active agents currently in the showroom, and a group of red avatars in the cafeteria, where the size of the group is proportional to the number of active agents that are currently in the cafeteria. This way, a user or manager can view the map of the organization, and quickly identify how many agents are located in each area of the organization, and what the total distribution of active agents is within the organization.

Similarly, the system 100 can generate a map of the organization, as described above, based on a predicted distribution of agents at a future time. This way, a user or manager can view the predicted map of the organization and quickly identify the future distribution of agents in the organization at the future time.

The status of agents, scheduling information, and distribution of agents can be dynamic, and can change with time. Consequently, in some embodiments, the graphical user interface can be dynamically updated or refreshed accordingly. Moreover, the system 100 can monitor activity, agent status information, agent schedules, agent assignments, transactions, reports, time-cards, customer demands, etc., to maintain the information displayed in the graphical user interface accurate and/or up-to-date.

FIG. 7A, and FIG. 7B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

1. A method comprising:
generating, via a processor, a graphical user interface comprising a resource scale representing a total number of resources in an environment and having a plurality of segments comprising;
an active resource segment representing a number of active resources from the total number of resources and an inactive resource segment representing a number of inactive resources from the total number of resources, wherein the active resource segment and the inactive resource segment are respectively sized according to the number of active resources and the number of inactive resources both relative to the total number of resources;
at least one active resource sub-segment representing a portion of resources from the number of active resources, wherein the portion of resources is associated with a resource activity, and wherein the at least one active resource sub-segment is sized according to the portion of resources relative to the number of active resources; and
presenting the graphical user interface at a display.

2. The method of claim 1, wherein the resource scale is presented at a primary display, the method further comprising:
presenting, via the graphical user interface, a secondary display including information pertaining to a sub-environment including a respective total number of resources scale and a respective active resource scale, both the respective total number of resources scale and the respective active resource scale being respective to the sub-environment.

3. The method of claim 1, wherein the resource scale comprises a graphical dial.

4. The method of claim 1, further comprising dynamically updating the resource scale at an expiration of a time interval.

5. The method of claim 4, further comprising retrieving data from an electronic schedule to determine the active resource segment based on a total number of resources scheduled to be active in the environment over the course of the period.

6. The method of claim 4, further comprising retrieving data from an electronic log of transactions to determine a number of resources having at least one of a first status and a second status, the first status corresponding to a first active sub-segment from the at least one active sub-segments and the second status corresponding to a second active sub-segment from the at least one active sub-segments.

7. A system comprising:
a processor; and
a computer-readable storage medium having stored therein instructions which, when executed by the processor, perform operations comprising:
generating a graphical user interface comprising a resource scale representing a total number of resources in an environment and having a plurality of segments comprising;
an active resource segment representing a number of active resources from the total number of resources and an inactive resource segment representing a number of inactive resources from the total number of resources, wherein the active resource segment and the inactive resource segment are respectively sized according to the number of active resources and the number of inactive resources both relative to the total number of resources;
at least one active resource sub-segment representing a portion of resources from the number of active resources, wherein the portion of resources is associated with a resource activity, and wherein the at least one active resource sub-segment is sized according to the portion of resources relative to the number of active resources; and
presenting the graphical user interface at a display.

8. The system of claim 7, wherein the resource scale is presented at a primary display, the computer-readable storage medium storing additional instructions which, when executed by the processor, result in an operation further comprising:
presenting, via the graphical user interface, a secondary display including information pertaining to a sub-environment including a respective total number of resources scale and a respective active resource scale, both the respective total number of resources scale and the respective active resource scale being respective to the sub-environment.

9. The system of claim 7, wherein the resource scale comprises a graphical dial.

10. The system of claim 9, the computer-readable storage medium storing additional instructions which, when executed by the processor, result in an operation further comprising retrieving data from an electronic schedule to determine the total number of resources scheduled to be active in the environment over the course of the period.

11. The system of claim 10, the computer-readable storage medium storing additional instructions which, when executed by the processor, result in an operation further comprising retrieving data from an electronic log of transactions to determine a number of resources having at least one of a first status and a second status.

12. A non-transitory computer-readable storage medium having stored therein instruction which, when executed by a processor, cause the processor to perform operations comprising:
generating a graphical user interface comprising an available agent a resource scale representing a total number of resources in an environment and having a plurality of segments comprising;
an active resource segment representing a number of active resources from the total number of resources and an inactive resource segment representing a number of inactive resources from the total number of resources, wherein the active resource segment and the inactive resource segment are respectively sized according to the number of active resources and the number of inactive resources both relative to the total number of resources;
at least one active resource sub-segment representing a portion of resources from the number of active resources, wherein the portion of resources is associated with a resource activity, and wherein the at least one active resource sub-segment is sized according to the portion of resources relative to the number of active resources; and
presenting the graphical user interface at a display.

13. The non-transitory computer-readable storage medium of claim 12, wherein the resource scale is presented at a primary display, the non-transitory computer-readable storage medium storing additional instructions which, when executed by the processor, result in an operation further comprising:
presenting, via the graphical user interface, a secondary display including information pertaining to a sub-environment including a respective total number of resources scale and a respective active resource scale, both the respective total number of resources scale and the respective active resource scale being respective to the sub-environment.

14. The non-transitory computer-readable storage medium of claim 12, wherein the resource scale comprises a graphical dial, and wherein the first status indicator portion includes a dynamic first status scale indicating a total number of resources having a first status.

15. The non-transitory computer-readable storage medium of claim 14, storing additional instructions which, when executed by the processor, result in an operation further comprising retrieving data from an electronic schedule to determine the total number of resources scheduled to be active in the environment over the course of the period.

16. The non-transitory computer-readable storage medium of claim 15, storing additional instructions which, when executed by the processor, result in an operation further comprising retrieving data from an electronic log of transactions to determine a number of resources having a first status.

17. A method comprising:
generating, via a processor, a graphical user interface comprising a first graphical dial which displays a first representation of a current number of active resources from a total number of resources at an organization, the first graphical dial having markings indicating a current distribution of the current number of active resources within areas of the organization;
predicting a future distribution of active resources within the areas of the organization, the active resources corresponding to a predicted number of resources from the total number of resources that will be active at a future time, wherein the future distribution is predicted for the future time; and
presenting, via the graphical user interface, a second graphical dial which displays a second representation of the predicted number of resources from the total number of resources that will be active at the future time, the second graphical dial having markings indicating the future distribution of active resources within the areas of the organization.

18. The method of claim 17, further comprising:
collecting current status information for all active resources in the organization; and
determining the current number of active resources and the current distribution of the current number of agents resources based on the current status information for all active resources.

19. The method of claim 18, wherein the current status information comprises, for each of the current number of active resources, at least one of a current location, a current task, a current assignment, a current area within the organization, and a schedule.

20. The method of claim 18, wherein the future distribution of active resources within the areas of the organization is based on at least one of respective schedules associated with the total number of resources at the organization, the current status information, current transactions, current activity associated with the areas within the organization, statistics associated with the organization, and a schedule associated with the organization.

21. The method of claim 18, wherein the current status information is automatically updated based on a detected change of status associated with at least one of the total number of resources at the organization.

22. The method of claim 17, wherein the first graphical dial is dynamically updated to reflect current status information for at least part of the total number of resources at the organization.

23. The method of claim 17, wherein the organization comprises a retail store, and wherein the areas within the organization comprise at least one of a department within the retail store or a category of activities associated with the retail store.

24. The method of claim 23, wherein the category of activities comprises one of customer service, sales, technical support, business operations, break, lunch, dinner, vacation, sick, or off.

25. The method of claim 17, wherein the organization comprises a retail store, and wherein the areas within the organization comprise at least one of a register, an entrance, a family room, a sales area, a technical support area, a service area, a showroom, a business area, a warehouse, or an employee area.

26. The method of claim 25, wherein the sales area is divided into a plurality of sales subareas based on at least one of associated products or associated services.

27. The method of claim 17, wherein the organization is calibrated each day based on a current total number of resources at the organization.

28. The method of claim 17, further comprising presenting, via the graphical user interface, a chart with a plurality of bars indicating respective numbers of active resources in each of the areas within the organization, wherein each of the plurality of bars is associated with an area within the organization, and wherein a respective length of each of the plurality of bars is proportional to a number of active resources in an associated area within the organization.

29. The method of claim 28, wherein at least one of the plurality of bars is user-selectable, the method further comprising:
receiving, via the graphical user interface, input from at device comprising a selection of an area within the organization to yield a selected area, the selected area corresponding to a bar from the plurality of bars; and
presenting, via the graphical user interface, a second chart with bars indicating active resources within subareas associated with the selected area, the bars having respective lengths proportional to the active resources within the subareas.

30. A graphical user interface comprising:
a first graphical dial which displays a first representation of a current number of active resources from a total number of resources at an organization, the first graphical dial having markings indicating a current distribution of the current number of active resources within areas of the organization;
a second graphical dial which displays a second representation of a predicted number of resources from the total number of resources that will be active at a future time, the second graphical dial having markings indicating a future distribution of active resources within the areas of the organization; and
a chart with a plurality of bars indicating respective numbers of active resources in each of the areas within the organization, wherein each of the plurality of bars is associated with an area within the organization, and wherein a respective length of each of the plurality of bars is proportional to a number of active resources in an associated area within the organization.
